(19) United States
(12) Patent Application Publication
(10) Pub. No.: US 2026/0316778 A1
(43) Pub. Date: Oct. 15, 2026

(54) RISK PREDICTION SYSTEM, RISK PREDICTION APPARATUS, AND RISK PREDICTION METHOD

(71) Applicant: BRIDGESTONE CORPORATION, Tokyo (JP)

(72) Inventor: Kodai SATO, Chuo-ku, Tokyo (JP)

(73) Assignee: BRIDGESTONE CORPORATION, Tokyo (JP)

(21) Appl. No.: 19/483,648

(22) PCT Filed: Nov. 28, 2023
(86) PCT No.: PCT/JP2023/042596

§ 371 Date: Nov. 12, 2025

(30) Foreign Application Priority Data
May 30, 2023 (JP) 2023-089013

(51) Int. Cl. B60W 50/14; B60C 23/04; B60W 50/00; B60W 50/02

(52) U.S. Cl. CPC B60W 50/14; B60C 23/0481; B60W 50/0097; B60W 50/0205; B60W 2050/146; B60W 2520/105; B60W 2530/10; B60W 2530/20; B60W 2552/15; B60W 2555/20; B60W 2556/10

(57) ABSTRACT

A risk prediction system includes a measurement unit, a controller, and an output interface. The measurement unit outputs measurement values of data items that enable quantitative calculation of internal failure occurrence factors of each first tire mounted on a vehicle. The controller calculates an accumulated amount of the internal failure occurrence factors of each first tire based on a history of the measurement values of the data item, and predicts a risk of failure occurrence for each first tire based on the accumulated amount. The output interface outputs the risk of failure occurrence for each first tire based on the risk predicted by the controller.

### TECHNICAL FIELD

The present disclosure relates to a risk prediction system, a risk prediction apparatus, and a risk prediction method.

### BACKGROUND

In order to realize a sustainable society, it is required to improve resource productivity by extending the service life of tires, which are a type of resource. In particular, for tires mounted on vehicles that repeatedly travel on rough roads and vehicles that transport heavy loads, it is required to maximize the service life of the tires through optimal use and management under severe operating conditions.

In improving tire service life, there are efforts addressing external damage and efforts addressing failures due to fatigue accumulated inside the tire. Compared to external damage, which can be detected and addressed by means such as visual inspection, failures due to internal fatigue are difficult to detect. As a measure against internal damage, conventionally, a sensor module is provided in the tire to measure the internal pressure and temperature of the tire. Techniques have been proposed for managing tires based on the measured values of the internal pressure and temperature of the tire (see, for example, PTL 1).

### CITATION LIST

### Patent Literature

PTL 1: JP 2007-91202 A

### SUMMARY

### Technical Problem

Conventionally, systems have been developed to promote proper use based on information obtained from tires, specifically, data acquired at a certain moment. However, prediction of failure occurrence risk due to continuous input has not been sufficient in the prior art, and sometimes responses were only made after a failure occurred. Furthermore, there has been a demand for further improvement in functions for effectively notifying prediction results.

Therefore, in view of these points, an object of the present disclosure is to provide a risk prediction system, a risk prediction apparatus, and a risk prediction method that improve the technology for predicting the risk of failure occurrence in tires.

### Solution to Problem

(1) A risk prediction system according to one aspect of the present disclosure includes: a measurement unit configured to output measurement values of data items that enable quantitative calculation of failure occurrence factors of each first tire mounted on a vehicle; a controller configured to calculate an accumulated amount of the failure occurrence factors of each first tire based on a history of the measurement values of the data items, and to predict a risk of failure occurrence for each first tire based on the accumulated amount; and an output interface configured to output a risk of failure occurrence for each first tire based on the risk predicted by the controller.
(2) A risk prediction system according to one embodiment of the present disclosure is the risk prediction system described in (1) above, wherein the data items may include one or a combination of two or more selected from environmental temperature, internal temperature of the first tire, internal air pressure of the first tire, loading weight of the vehicle, traveling speed of the vehicle, acceleration of the vehicle, and road gradient of a road traveled by the vehicle.
(3) A risk prediction system according to one embodiment of the present disclosure is the risk prediction system described in (1) or (2) above, wherein the output interface can display, in stages, the risk of failure occurrence for each first tire based on the risk.
(4) A risk prediction system according to one embodiment of the present disclosure is the risk prediction system described in any one of (1) to (3) above, wherein the controller can predict the risk of failure occurrence for the first tire based on the accumulated amount of the failure occurrence factors over a predetermined period.
(5) A risk prediction system according to one embodiment of the present disclosure is the risk prediction system described in any one of (1) to (4) above, wherein the failure occurrence factors may correspond to a fatigue accumulation state of the first tire.
(6) A risk prediction system according to one embodiment of the present disclosure is the risk prediction system described in (5) above, wherein the fatigue accumulation state is a fatigue accumulation state due to thermal aging, and the data items may include the internal temperature of the first tire.
(7) A risk prediction system according to one embodiment of the present disclosure is the risk prediction system described in (5) above, wherein the fatigue accumulation state is a fatigue accumulation state due to strain, and the data items may include acceleration of the vehicle.
(8) A risk prediction system according to one embodiment of the present disclosure is the risk prediction system described in any one of (1) to (7) above, wherein the risk prediction system includes an analysis unit configured to determine a threshold for the accumulated amount of the failure occurrence factors for predicting the risk, based on data of a plurality of discarded second tires, the data of each second tire including a cause of discarding the second tire and information on the history of the data items, wherein the cause of discarding the tire includes abnormality-based failure and normal lifetime, and the controller can predict the risk of failure occurrence for each tire using the threshold.
(9) A risk prediction system according to one embodiment of the present disclosure is the risk prediction system described in (8) above, wherein the analysis unit includes two thresholds for the accumulated amount of the failure occurrence factors, and the two thresholds can demarcate a range in which discarding occurs due to normal lifetime, a range in which discarding cannot be specifically identified as due to either normal lifetime or abnormality-based failure, and a range in which discarding occurs due to abnormality-based failure.
(10) A risk prediction system according to one embodiment of the present disclosure is the risk prediction system described in (8) or (9) above, wherein the analysis unit acquires the data of the second tires including a plurality of data items, and can determine, from among the plurality of data items, the data items to be used for calculation of the failure occurrence factors based on the types of data items included in the plurality of data items and the required accuracy of the risk prediction.
(11) A risk prediction system according to one embodiment of the present disclosure is the risk prediction system described in any one of (8) to (10) above, wherein the data items may be determined by a phenomenon of the abnormality-based failure included in the data of the second tires.
(12) A risk prediction system according to one embodiment of the present disclosure is the risk prediction system described in any one of (8) to (11) above, wherein the controller can predict, based on the threshold, a timing at which failure occurs in each first tire by extrapolating the accumulated amount of the failure occurrence factors in a time series.
(13) A risk prediction system according to one embodiment of the present disclosure is the risk prediction system described in any one of (1) to (12) above, wherein the controller acquires maintenance information including at least one of maintenance frequency and maintenance plan of the first tire, determines a countermeasure for the risk based on the maintenance information and the accumulated amount of the failure occurrence factors of each first tire, and the output interface can output the determined countermeasure.
(14) A risk prediction apparatus according to one aspect of the present disclosure includes: an acquisition interface configured to acquire measurement values of data items that enable quantitative calculation of failure occurrence factors of each first tire mounted on a vehicle; a controller configured to calculate an accumulated amount of the failure occurrence factors of each first tire based on a history of the measurement values of the data items, and to predict a risk of failure occurrence for each first tire based on the accumulated amount; and an output interface configured to output a risk of failure occurrence for each first tire based on the risk predicted by the controller.
(15) A risk prediction method according to one aspect of the present disclosure is a risk prediction method executed by a computer, comprising: acquiring measurement values of data items that enable quantitative calculation of failure occurrence factors of each first tire mounted on a vehicle; calculating an accumulated amount of the failure occurrence factors of each first tire based on a history of the measurement values of the data items; predicting a risk of failure occurrence for each first tire based on the accumulated amount; and outputting a risk of failure occurrence for each first tire based on the predicted risk.

### Advantageous Effect

According to the risk prediction system, risk prediction apparatus, and risk prediction method of the present disclosure, the technology for predicting the risk of failure occurrence in tires is improved. In particular, in this risk prediction system, risk prediction apparatus, and risk prediction method, the risk of failure occurrence in the first tire is predicted based on a history of measurement values of data items that enable quantitative calculation of failure occurrence factors. This makes it possible to predict the risk in response to failures that occur due to accumulation of failure occurrence factors and to present it to the user.

### BRIEF DESCRIPTION OF THE DRAWINGS

In the accompanying drawings:

FIG. 1 is a block diagram illustrating a schematic configuration of a risk prediction system according to one embodiment;

FIG. 2 is a diagram illustrating an example of data stored in the storage unit of FIG. 1;

FIG. 3 is a diagram explaining an example of the contents of data stored as past tire data in FIG. 2;

FIG. 4 is a diagram illustrating an example of countermeasures according to risk levels;

FIG. 5 is a diagram illustrating an example of a method for setting thresholds by the analysis unit of FIG. 1;

FIG. 6 is a diagram explaining a method for predicting the timing of failure occurrence using thresholds;

FIG. 7 is a diagram illustrating an example of countermeasures including tire rotation displayed on the display unit;

FIG. 8 is a flowchart illustrating an example of processing executed by the analysis unit of FIG. 1; and

FIG. 9 is a flowchart illustrating an example of processing executed by the risk prediction unit of FIG. 1;

Hereinafter, embodiments of the present disclosure will be described with reference to the drawings.

### Overall Configuration

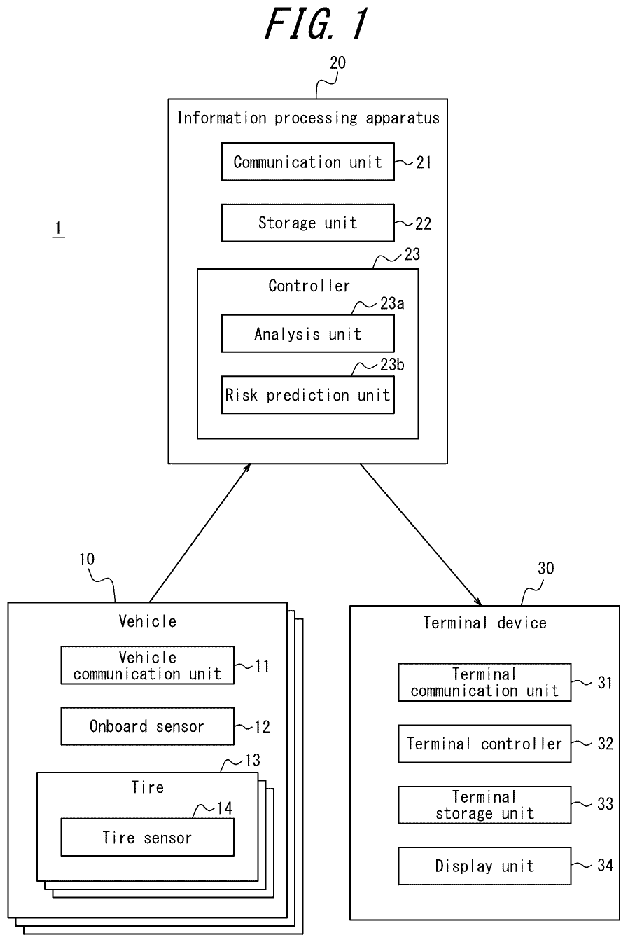

FIG. 1 illustrates a schematic configuration of a risk prediction system 1 according to an embodiment of the present disclosure. The risk prediction system 1 includes a vehicle 10, an information processing apparatus 20, and a terminal device 30. The risk prediction system 1 is a system that predicts the risk of failure occurrence (hereinafter also referred to as “failure occurrence risk”) in a tire 13, based on measurement data of tires that have been discarded in the past and measurement data regarding the currently used tire 13 acquired from the vehicle 10. The predicted risk is, for example, displayed on the display unit 34 of the terminal device 30.

### Configuration of the Vehicle

The vehicle 10 includes large trucks, vehicles for vehicle transport, special vehicles for construction and civil engineering, as well as vehicles used in special environments such as mines. The vehicle 10 may also include single-wheel vehicles, motorcycles (two-wheeled vehicles), passenger vehicles, and/or small trucks. The vehicle 10 includes vehicles of the same type managed by a specific user. For example, the user may be a manager of large trucks, and the vehicle 10 is a large truck managed by the user.

The vehicle 10 includes a vehicle communication unit 11, an onboard sensor 12, and a tire 13. A tire sensor 14, which performs measurement inside the tire, is disposed in the tire 13.

The vehicle communication unit 11 provides a communication function for communicating with external devices of the vehicle 10, such as the information processing apparatus 20, and internal devices of the vehicle 10, such as the tire sensor 14 inside the tire 13. The vehicle communication unit 11 includes a communication module that connects to a communication network such as the Internet. The vehicle communication unit 11 may include a communication module compatible with mobile communication standards such as 4G (4th Generation) or 5G (5th Generation). The vehicle communication unit 11 may include a communication module compatible with wired LAN standards (for example, 1000BASE-T as an example). The vehicle communication unit 11 may include a communication module compatible with wireless LAN standards (for example, IEEE802.11 as an example). The vehicle communication unit 11 may include a communication module compatible with short-range communication such as Bluetooth and BLE.

The onboard sensor 12 is a sensor disposed within the vehicle 10. The onboard sensor 12 may include one or more of an environmental temperature sensor, a loading weight sensor, a vehicle speed sensor, an accelerometer, and an inclination sensor. The onboard sensor 12 is included in the measurement unit.

The environmental temperature sensor is a sensor that measures the temperature around the vehicle 10. The temperature measurement may include those using thermocouples, those using thermistors, and the like.

The loading weight sensor is a sensor that detects the load loaded on the vehicle 10. As a sensor for detecting load, for example, a sensor using a strain gauge that measures deformation due to load is used. The loading weight sensor may be attached to the suspension of the vehicle 10, for example, and can measure the load applied to each tire 13.

The vehicle speed sensor is a sensor that detects the traveling speed of the vehicle 10 during travel. To acquire the traveling speed, a signal from a vehicle speed sensor used in the vehicle 10 for conventional speedometer display can be used. The vehicle 10 may have a sensor that detects position information, such as a GPS (Global Positioning System) receiver, and may calculate speed from changes in position information.

The accelerometer is a sensor that detects the acceleration of the vehicle 10 during travel. The accelerometer includes various types such as mechanical displacement measurement type, optical type, and semiconductor type. Semiconductor-type accelerometers include various types such as piezoresistive type, capacitive type, and gas temperature distribution type.

The inclination sensor measures the gradient of the road on which the vehicle 10 travels, that is, whether it is an uphill or downhill and the angle. Inclination sensors include sensors that detect inclination based on the orientation of a liquid surface, and sensors that detect inclination angle based on outputs from accelerometers and gyro sensors.

The vehicle 10 is equipped with one or more tires 13. The number of tires 13 may be one or more, for example, 6, 8, 10, and so on. However, the number of tires 13 is not limited to even numbers.

The tire sensor 14 may include an internal temperature sensor that detects the temperature inside the tire 13, and an internal pressure sensor that detects the pressure (air pressure) inside the tire. The internal pressure sensor may employ any known pressure sensor, including piezoresistive sensors and capacitive sensors. The internal temperature sensor and the internal pressure sensor may detect the internal temperature and air pressure of the tire 13 in a time series at predetermined time intervals (for example, once per minute) under predetermined conditions (for example, vehicle speed of 40 km/h or more). The temperature and air pressure inside the tire may utilize output from a tire pressure monitoring system (TPMS: Tire Pressure Monitoring System). The tire sensor 14 can transmit the measured data to the vehicle communication unit 11. The tire sensor 14 is included in the measurement unit.

Each measurement value of the data items measured by the onboard sensor 12 and the tire sensor 14 is used in the information processing apparatus 20 to predict the risk for each tire. For example, data on the internal temperature of the tire 13 is used to evaluate the fatigue accumulation state due to thermal aging of the tire. In addition, since the acceleration data corresponds to the force applied to the tire, it is used to evaluate the fatigue accumulation state due to strain of the tire. Note that “fatigue” of the tire means that the strength decreases and failure is more likely to occur as the tire repeatedly and/or continuously receives loads such as heat and stress.

The vehicle 10 can sequentially or for a certain period accumulate the measurement values of each data item acquired from the onboard sensor 12 and the tire sensor 14, which are the measurement unit, and then transmit them to the information processing apparatus 20. Here, the data items include one or a combination of two or more selected from environmental temperature, internal temperature of the tire 13, internal air pressure of the tire 13, loading weight of the vehicle 10, traveling speed of the vehicle 10, acceleration of the vehicle 10, and road gradient of a road traveled by the vehicle 10. The vehicle 10 may have a storage device for storing the measurement values of the data items. The risk prediction system 1 can predict the risk of failure occurrence in the tire 13 using the above data items acquired from the tire 13 and the vehicle 10.

### Configuration of the Information Processing Apparatus

The information processing apparatus 20 is a computer such as a server computer, workstation, or PC (Personal Computer). The information processing apparatus 20 includes a communication unit 21, a storage unit 22, and a controller 23. The information processing apparatus 20 functions as a risk prediction apparatus.

The communication unit 21 provides a communication function for communicating with external devices of the information processing apparatus 20. Like the vehicle communication unit 11, the communication unit 21 includes a communication module that connects to a communication network such as the Internet. The communication unit 21 functions as an acquisition unit that acquires measurement values of one or more data items that enable quantitative calculation of internal failure occurrence factors of the tire 13.

The storage unit 22 includes one or more memories. The memory may be, for example, a semiconductor memory, magnetic memory, or optical memory, but is not limited thereto and may be any memory. The semiconductor memory may include volatile memory such as RAM (Random Access Memory), and non-volatile memory such as ROM (Read Only Memory) and flash memory. The magnetic memory may include, for example, a hard disk and magnetic tape. The optical memory may include, for example, a CD (Compact Disc), DVD (Digital Versatile Disc), and BD (Blu-ray® (Blu-ray is a registered trademark in Japan, other countries, or both) Disc).

The storage unit 22 stores information necessary for the controller 23 of the information processing apparatus 20 to perform processing, and information generated as a result of processing by the controller 23. The storage unit 22 may store a program for operating the controller 23.

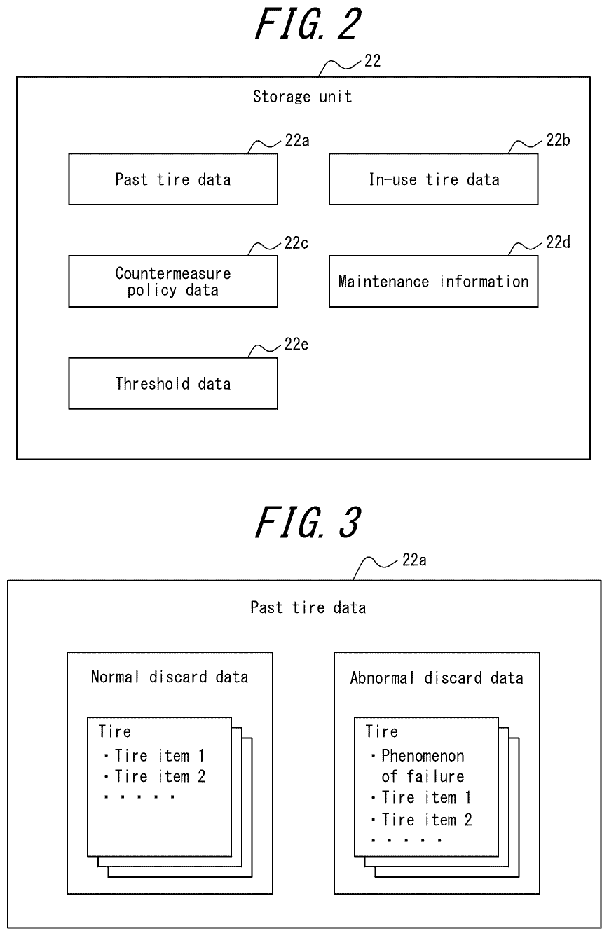

The storage unit 22 may include, as information for the controller 23 to perform processing, for example, past tire data 22a, in-use tire data 22b, countermeasure policy data 22c, maintenance information 22d, and threshold data 22e, as illustrated in FIG. 2.

The past tire data 22a is data that accumulates data of tires discarded in the past. A discarded tire means a tire that can no longer be used and is no longer in use. Hereinafter, a tire discarded in the past may be referred to as a second tire. As the past tire data 22a, data of the type of tire that is the subject of risk prediction provided by the user can be used. Alternatively, the past tire data 22a may be extracted from data collected by the information processing apparatus 20 from the vehicle 10 after the tire 13 has been discarded. For example, as illustrated in FIG. 3, in the past tire data 22a, the data of the second tire may be managed separately as normal discard data and abnormal discard data for each of the two causes: discard due to normal lifetime and discard due to abnormality based failure.

The normal discard data may include, for each tire, time-series historical data of data items measured by the measurement unit and/or data of their cumulative values. In the present application, “history” or “historical data” means a group of data measured or acquired in the past in a time series. The abnormal discard data may include, for each tire, the phenomenon of failure and data of the same data items as the normal discard data. The phenomenon of failure includes information on where and how the tire failed. For example, the phenomenon of failure includes “separation from the belt end due to heat-induced causes” and “separation from the belt end due to strain,” and the like. The method of managing past tire data is not limited to the above. For example, all data of the second tire may be managed in a table, and the items of the table may include an item indicating whether the tire was discarded normally or due to abnormality based failure, and an item indicating the phenomenon of failure.

The in-use tire data 22b is data that stores and accumulates measurement values of each data item in the past time series acquired from a plurality of vehicles 10 via the communication unit 21. The in-use tire data 22b is stored in association with each tire 13. That is, the in-use tire data 22b is data regarding the currently used tire 13.

The countermeasure policy data 22c is data that defines a countermeasure policy for the risk of failure occurrence in the tire 13. The countermeasure policy data 22c is defined according to the user's preference. The countermeasure policy data 22c defines countermeasures (actions) to be taken when a risk of failure occurrence in the tire 13 arises. The countermeasure policies in the countermeasure policy data 22c include, for example, the following:

### (1) Emphasis on Long-Term Use of Tires

This policy emphasizes using each tire 13 for as long as possible. When the risk of failure occurrence in some of the tires mounted on the vehicle 10 increases, as a countermeasure, the internal air pressure of the tire is adjusted, and operations with less load on the tire are performed.

### (2) Emphasis on Vehicle Operation Rate

This policy emphasizes continued use of the vehicle 10 to suppress opportunity loss during periods when the vehicle 10 cannot be used. Therefore, tire rotation is minimized, and risk reduction is performed by adjusting internal pressure and the like.

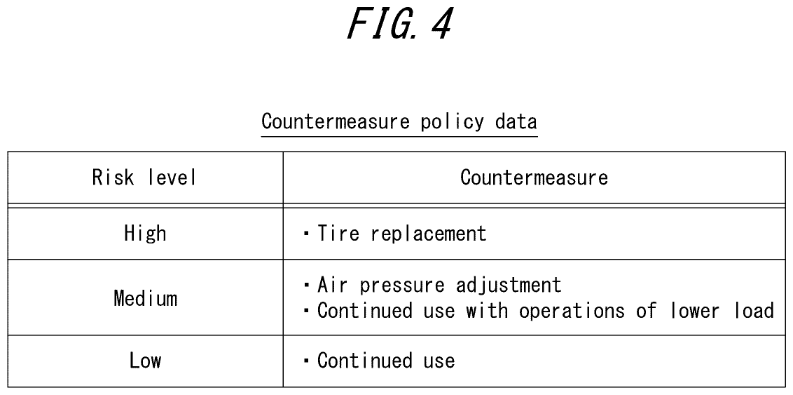

An example of the countermeasure policy data 22c emphasizing long-term use of the tire 13 is illustrated in FIG. 4. In this case, countermeasure policies corresponding to the magnitude of the risk level are defined. In the case of FIG. 4, when the risk level of the tire is high, tire replacement is adopted. When the risk level is moderate, countermeasures such as air pressure adjustment or transition to operations with less thermal and/or force load on the tire are adopted. When the risk level is low, the tire continues to be used as is. The content of the countermeasures included in the countermeasure policy data 22c may be presented to the user when there is a risk of failure occurrence in the tire 13.

The maintenance information 22d includes information on the maintenance frequency and/or maintenance plan of the tire 13. The maintenance information 22d of the tire 13 is also maintenance information of the vehicle 10. The maintenance frequency includes, for example, information on the interval at which the vehicle 10 is inspected and maintained at a maintenance facility for the vehicle 10. The maintenance plan includes information on the date and time of the next inspection and maintenance of the vehicle 10. This information may be used by the information processing apparatus 20 to determine countermeasures to be taken against the risk of failure occurrence in the tire 13.

The threshold data 22e stores thresholds for the accumulated amount of failure occurrence factors. The threshold data 22e is data of thresholds determined by the analysis unit 23a, which will be described later, of the controller 23 based on the past tire data 22a. The failure occurrence factors represent causes that induce failure in the tire. The failure occurrence factors include, for example, the fatigue accumulation state due to thermal aging inside the tire, and the mechanical fatigue accumulation state due to strain, and the like. The accumulated amount of the failure occurrence factors is used as an evaluation index for evaluating the risk of failure occurrence in the tire. As will be described later, the accumulated amount of the failure occurrence factors is quantitatively calculated based on historical information of one or more data items.

The controller 23 includes one or more processors. The processor may be a general-purpose processor such as a CPU (Central Processing Unit) that executes a program defining control procedures, or may be a dedicated processor specialized for specific processing. The controller 23 performs arithmetic processing for executing each function of the information processing apparatus 20 and controls each component of the information processing apparatus 20. As illustrated in FIG. 1, the controller 23 may include an analysis unit 23a and a risk prediction unit 23b.

### Processing of the Analysis Unit

The analysis unit 23a determines a threshold for the accumulated amount of failure occurrence factors used to predict the risk of failure occurrence, based on the past tire data 22a stored in the storage unit 22.

For example, the analysis unit 23a extracts those with a large number of occurrences as the phenomenon of failure from the abnormal discard data of the past tire data 22a. The analysis unit 23a identifies the failure occurrence factors for the phenomenon of failure. For example, if the phenomenon of failure is “separation from the belt end due to heat-induced causes,” the failure occurrence factor includes “fatigue accumulation due to thermal aging.” The relationship between the phenomenon of failure and the failure occurrence factors may be stored in advance as a table in the storage unit 22. In addition, the phenomenon of failure to be analyzed and the corresponding failure occurrence factors may be determined by the user and input to the information processing apparatus 20. Since the phenomenon of failure is associated with the failure occurrence factors based on the abnormal discard data of the past tire data 22a, and the failure occurrence factors are quantitatively evaluated by one or more data items as described later, the data items used for calculating the failure occurrence factors are determined by the phenomenon of failure. Thus, data items corresponding to the failure occurrence factors that affect the actual phenomenon of failure due to abnormality can be determined according to the phenomenon of failure.

The storage unit 22 may store, in advance, data items and mathematical expressions for quantitatively evaluating the accumulated amount of failure occurrence factors. For example, if the fatigue accumulation state due to thermal aging of the tire depends on data items including the internal temperature of the tire, the storage unit 22 stores a mathematical expression for calculating the fatigue accumulation state due to thermal aging from historical data of a plurality of data items including the internal temperature of the tire. The analysis unit 23a can use predetermined types of data items for analysis of the risk of failure occurrence. The data items for quantitatively evaluating the accumulated amount of failure occurrence factors by the analysis unit 23a are not limited to one and may be a plurality of data items. In addition, the analysis unit 23a may determine which data items of the past tire data 22a to use for evaluating the failure occurrence factors based on the accuracy of risk prediction when each data item is used. That is, the analysis unit 23a may select the items to be used so that the accuracy of risk prediction required by the user is exceeded by the accuracy of risk prediction when each data item is used. The storage unit 22 may have a table indicating which range of data items should be used to satisfy the requirements for the accuracy of risk prediction input by the customer. Alternatively, such selection of data items may be determined outside the information processing apparatus 20 and input to the information processing apparatus 20.

Note that the mathematical expression for calculating the failure occurrence factors from the history of measurement values of one or more data items may use one obtained in advance by analyzing data of a large number of tires.

The analysis unit 23a compares the distribution of the accumulated amount of failure occurrence factors for tire data included in the normal discard data and for tire data having the target phenomenon of failure included in the abnormal discard data, and can determine a threshold based on this comparison to predict the risk.

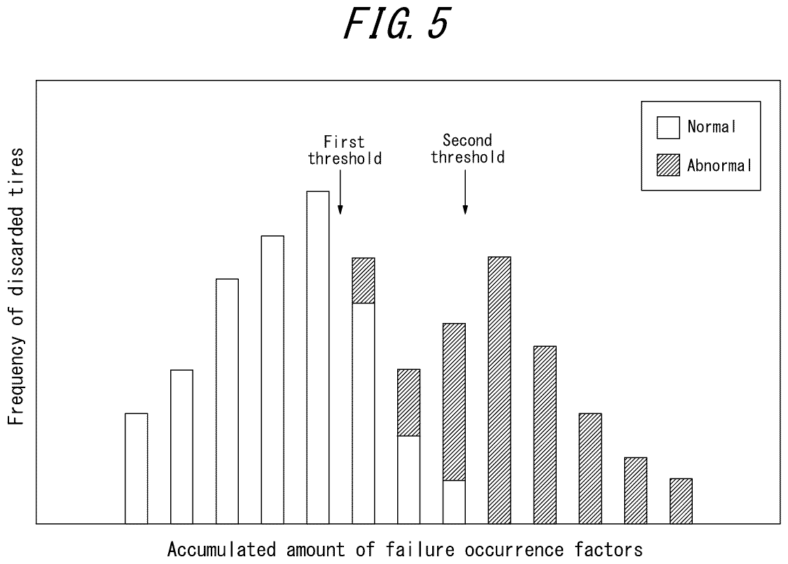

As an example, the analysis unit 23a can, for each of the tires in the normal discard data and the abnormal discard data having the phenomenon of the target failure, create a frequency distribution, as illustrated in FIG. 5, using the accumulated amount of the failure occurrence factors as a parameter. In FIG. 5, the white bars indicate the frequency of the tires in the normal discard data, and the black bars indicate the frequency of the tires in the abnormal discard data. The analysis unit 23a can set a first threshold at the boundary between the accumulated amount of the failure occurrence factors for only the normal discard data and the accumulated amount for which both the normal discard data and the abnormal discard data are mixed. Further, the analysis unit 23a can set a second threshold at the boundary between the accumulated amount of the failure occurrence factors for which both the normal discard data and the abnormal discard data are mixed and the accumulated amount for only the abnormal discard data. The first threshold is a threshold at which, if the accumulated amount of the failure occurrence factors is equal to or less than this value, it is predicted that the tire will not be discarded due to the phenomenon of the target failure, but will be discarded due to normal lifetime. The second threshold is a threshold at which, if the accumulated amount of the failure occurrence factors exceeds this value, it is predicted that the tire will be discarded due to the phenomenon of the target failure. In addition, the accumulated amount of the failure occurrence factors between the first and second thresholds is a gray zone in which it is unclear whether a failure due to the phenomenon of the target failure will occur. The two thresholds demarcate the accumulated amount of the failure occurrence factors into a range in which discarding occurs due to normal lifetime, a range in which discarding cannot be specifically identified as due to either normal lifetime or abnormality based failure, and a range in which discarding occurs due to abnormality based failure.

The analysis unit 23a stores the determined first and second thresholds as threshold data 22e in the storage unit 22. Note that the analysis unit 23a does not necessarily need to determine two thresholds; for example, it may set only the first threshold, or may determine a single threshold between the first and second thresholds. Further, the analysis unit 23a may set three or more thresholds.

### Processing of the Risk Prediction Unit

The risk prediction unit 23b can predict the risk of failure occurrence for the tire 13 using the in-use tire data 22b collected for the currently used tire 13 and the thresholds stored as threshold data 22e in the storage unit 22. The risk prediction unit 23b calculates the accumulated amount of the internal failure occurrence factors for each tire 13 based on the history of the measurement values of the data items corresponding to the phenomenon of the target failure. The risk prediction unit 23b predicts the risk of failure occurrence for each tire 13 based on the accumulated amount of the failure occurrence factors.

For example, the importance of the risk of failure occurrence can be determined based on the accumulated amount of the failure occurrence factors relative to the thresholds stored as threshold data 22e. For example, the risk prediction unit 23b may determine that the importance of the risk of failure occurrence is moderate if the accumulated amount of the failure occurrence factors for the tire 13 is 70% or more of the threshold. Further, the risk prediction unit 23b may determine that the importance of the risk of failure occurrence is high if the accumulated amount of the failure occurrence factors is 90% or more of the threshold. The values such as 70% and 90% above are merely examples. The risk prediction unit 23b can evaluate the magnitude of the risk of failure occurrence by providing various criteria relative to the threshold. Since the risk prediction unit 23b predicts the risk of failure occurrence for the currently used tire 13 using thresholds determined based on data of a plurality of previously discarded tires, the prediction accuracy is improved.

Further, when the risk prediction unit 23b has two thresholds, the first and second thresholds, it can predict the risk of failure occurrence for the tire by dividing the accumulated amount of the failure occurrence factors into three stages: less than the first threshold, equal to or greater than the first threshold and less than the second threshold, and equal to or greater than the second threshold. This enables the risk prediction unit 23b to provide multi-stage output according to the risk of failure occurrence for each first tire.

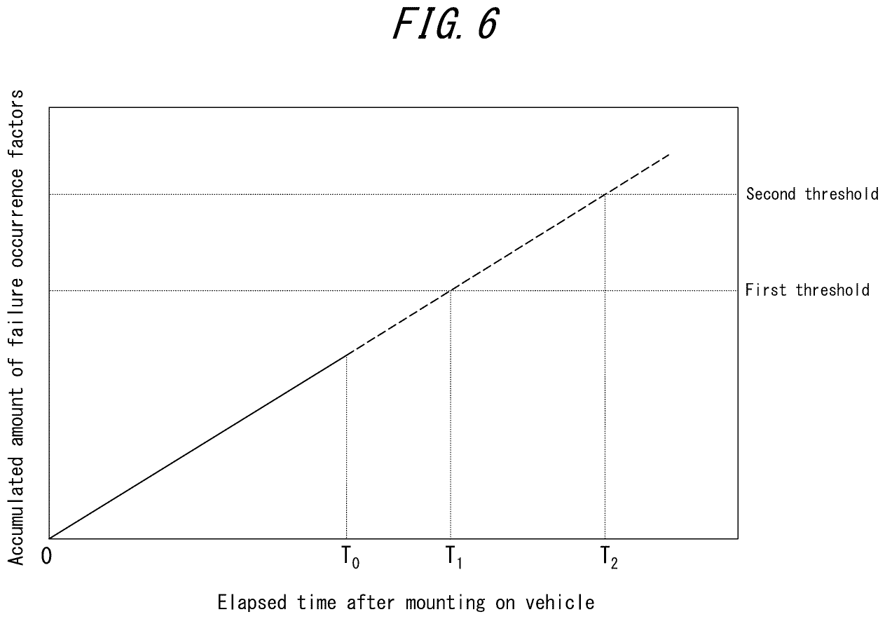

Further, for example, as illustrated in FIG. 6, the risk prediction unit 23b can predict, based on the thresholds, the timing at which failure occurs in each tire 13 by extrapolating the time-series accumulated amount of the failure occurrence factors. The horizontal axis in FIG. 6 indicates the elapsed time after the tire 13 is mounted on the vehicle, and the vertical axis indicates the accumulated amount of the failure occurrence factors. In FIG. 6, the current time is T₀. The risk prediction unit 23b predicts the timing T₁ at which the accumulated amount of the failure occurrence factors reaches the aforementioned first threshold, and the timing T₂ at which it reaches the aforementioned second threshold, based on the change in the accumulated amount of the failure occurrence factors after the tire 13 is mounted on the vehicle 10. In this case, the risk prediction unit 23b can predict that failure will occur between the timings T₁ and T₂. In this way, by extrapolating the graph of the accumulated amount of the failure occurrence factors with respect to elapsed time, it becomes possible to predict the time until failure occurs in the tire 13. As a result, the accuracy of predicting the timing of failure occurrence when the tire 13 is actually used is improved.

When the risk prediction unit 23b predicts the risk of failure occurrence, it generates a notification according to the importance of the risk and/or the predicted timing of failure occurrence, and transmits it to the terminal device 30. The risk prediction unit 23b may transmit information on possible countermeasures according to the importance of the risk to the terminal device 30 based on the countermeasure policy data 22c. Further, the risk prediction unit 23b may determine, based on the information on the predicted timing T₁ and/or T₂ of failure occurrence and the maintenance information 22d, for example, whether to wait until the next inspection to implement a countermeasure or to implement a countermeasure immediately.

The analysis unit 23a and the risk prediction unit 23b do not need to be mounted on the same information processing apparatus 20. For example, the risk prediction system 1 may have the function of the analysis unit 23a, which analyzes past tire data 22a, and the function of the risk prediction unit 23b, which predicts the risk of failure occurrence for the currently used tire 13, on different hardware.

### Configuration of the Terminal Device

The terminal device 30 includes computers such as PCs and portable information terminals such as smartphones. The terminal device 30 may be disposed at the business office of the operator who operates the vehicle 10 and/or inside the currently operating vehicle 10. The terminal device 30 includes a terminal communication unit 31, a terminal controller 32, a terminal storage unit 33, and a display unit 34.

The terminal communication unit 31 provides a communication function with other devices. The terminal communication unit 31 includes a communication module that connects to a communication network such as the Internet.

The terminal controller 32, like the controller 23 of the information processing apparatus 20, includes one or more processors. The terminal controller 32 can receive information from the information processing apparatus 20 via the terminal communication unit 31 and display its content on the display unit 34.

The terminal storage unit 33, like the storage unit 22 of the information processing apparatus 20, includes one or more memories. The terminal storage unit 33 may store information used for processing by the terminal controller 32.

The display unit 34 is a display for presenting various types of information. The display unit 34 may include, for example, a liquid crystal display and an organic EL (Electro Luminescence) display, but is not limited thereto. The display unit 34 can present notifications received from the information processing apparatus 20 by text display or graphical display using a GUI (Graphical User Interface). The display unit 34 functions as an output interface.

The terminal device 30 further includes input devices such as a keyboard and/or a touch panel, and may be configured to transmit to the information processing apparatus 20 the required accuracy for risk evaluation, countermeasure policy data, and/or maintenance information.

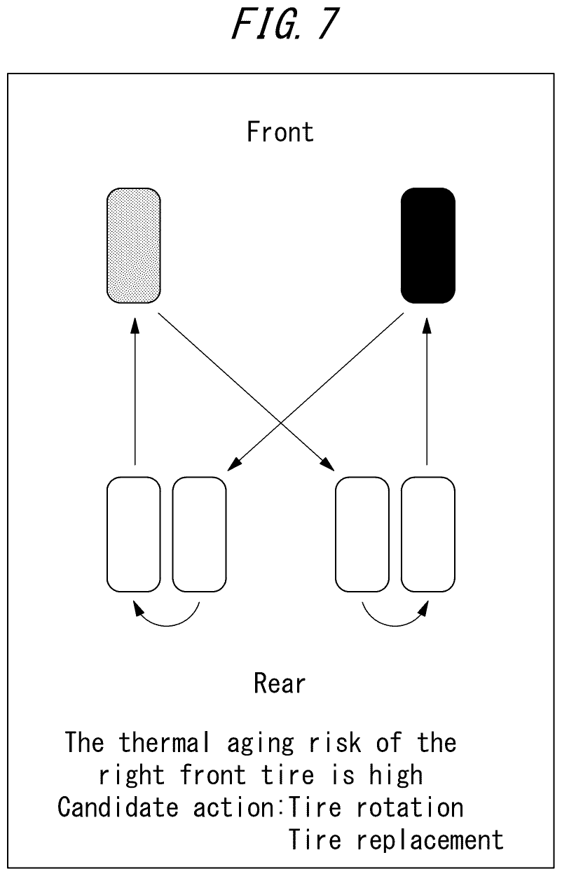

The terminal controller 32 of the terminal device 30 receives notifications from the information processing apparatus 20 via the terminal communication unit 31 and displays the risk of failure occurrence for the tire 13 mounted on the vehicle 10 on the display unit 34. As one example, as illustrated in FIG. 7, the display unit 34 of the terminal device 30 may present the position and risk of the tires of the vehicle 10 using images. Further, the display unit 34 may present candidate countermeasures that can be taken for the risk of failure occurrence for the tire 13.

The display unit 34 can present the risk of failure occurrence for the in-use tire 13 in two or more stages by changing the display color and/or display mode according to the importance of the risk of failure occurrence and/or the predicted timing of failure occurrence.

### Method for Determining Thresholds Based on Past Tire Data by the Analysis Unit

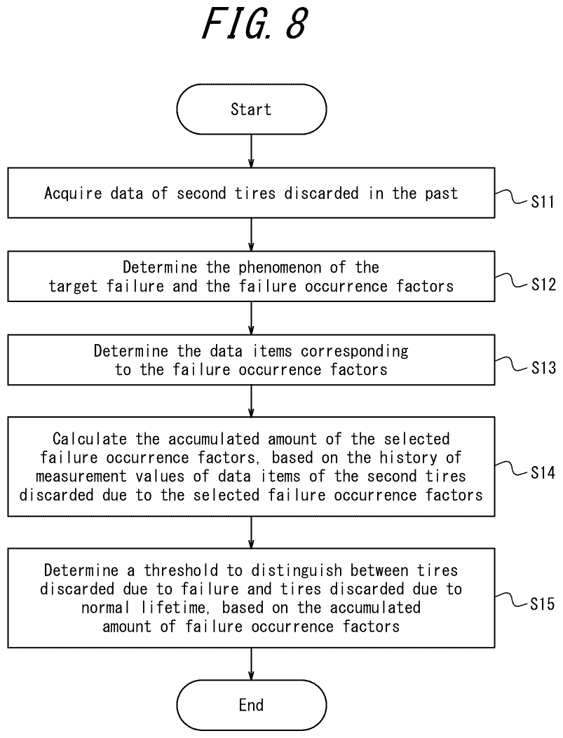

Below, with reference to the flowchart in FIG. 8, a method for determining thresholds used to determine the risk of failure occurrence for the in-use tire 13 based on data of tires (second tires) discarded in the past will be described.

First, the information processing apparatus 20 acquires data of the second tires discarded in the past (step S11). As illustrated in FIG. 3, the data of the second tires includes data of tires discarded due to normal lifetime and data of tires discarded due to abnormal failure.

Next, the analysis unit 23a determines the phenomenon of the failure to be analyzed and the failure occurrence factors corresponding to the phenomenon (step S12). The phenomenon of the failure to be analyzed may be selected by the analysis unit 23a from among the phenomena of frequent failures in the past tire data 22a, which is the data of the second tires, or may be input to the information processing apparatus 20 by the user. The failure occurrence factors corresponding to the phenomenon of the failure may be stored as a table in the storage unit 22 of the information processing apparatus 20, or may be input to the information processing apparatus 20 by the user.

The analysis unit 23a determines the data items corresponding to the failure occurrence factors (step S13). For example, the relationship between the accumulated amount of the failure occurrence factors and specific data items may be stored in advance as a mathematical expression in the storage unit 22. The analysis unit 23a may select only the data items that have a large impact on the accumulation degree of the failure occurrence factors from among a plurality of data items, based on the accuracy of risk prediction required by the user.

The analysis unit 23a calculates the accumulated amount of the selected failure occurrence factors for each of the data of tires discarded due to normal lifetime and the data of tires discarded due to abnormal failure, based on the history of the measurement values of the data items of the second tires (step S14).

The analysis unit 23a determines a threshold for distinguishing between tires discarded due to failure and tires discarded due to normal lifetime, based on the accumulated amount of the failure occurrence factors (step S15). The threshold thus determined is stored as threshold data 22e in the storage unit 22 for use in predicting the risk of failure occurrence for the in-use tire 13 (first tire) by the risk prediction unit 23b.

### Risk Prediction Method by the Risk Prediction Unit

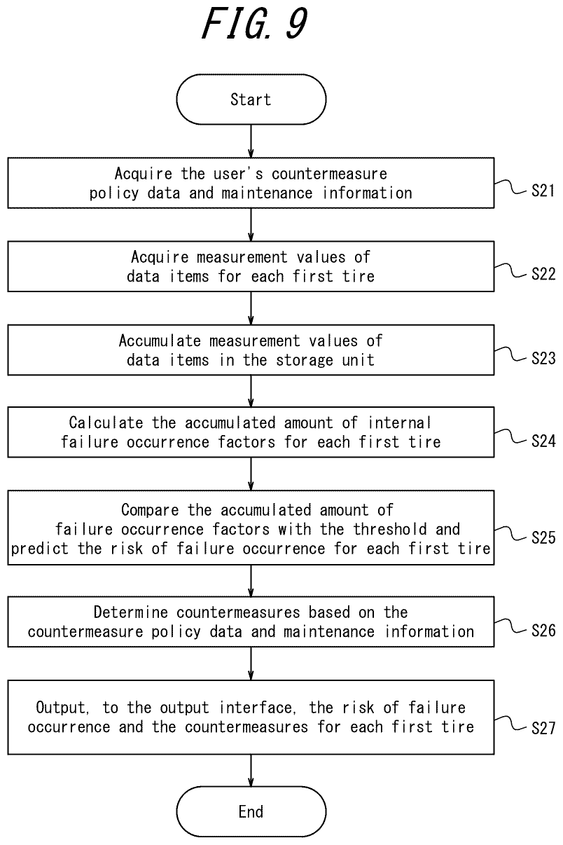

Below, with reference to the flowchart in FIG. 9, a method for predicting the risk of failure occurrence for the in-use tire 13 (first tire) will be described.

First, the information processing apparatus 20 acquires the user's countermeasure policy data 22c and maintenance information 22d in advance (step S21).

The risk prediction unit 23b sequentially acquires, for each tire 13 (first tire), the measurement data of specific data items related to the phenomenon of the target failure from the vehicle 10 (step S22).

The risk prediction unit 23b accumulates the acquired measurement values of the data items as in-use tire data 22b in the storage unit 22 (step S23). The in-use tire data 22b may record the measurement values of specific data items of the currently used vehicle 10 in a time series.

The risk prediction unit 23b calculates the accumulated amount of the failure occurrence factors for each first tire based on the history of the specific data items of the in-use tire data 22b, which is sequentially updated (step S24).

The analysis unit 23a compares the accumulated amount of the failure occurrence factors calculated in step S24 with the threshold determined in step S15 of FIG. 8, and predicts the risk of failure occurrence for each first tire (step S25). The predicted risk may include information on the importance of the risk and/or the predicted timing of failure occurrence.

The analysis unit 23a determines countermeasures based on the information on the importance of the risk and/or the predicted timing of failure occurrence, the countermeasure policy data 22c, and the maintenance information (step S26).

The analysis unit 23a causes the output interface to present the risk of failure occurrence and countermeasures for each first tire (step S27). For example, the analysis unit 23a transmits the predicted risk and information on countermeasures to the terminal device 30 via the communication unit 21, thereby causing the display unit 34 of the terminal device 30 to present the risk of failure occurrence and countermeasures for each first tire. The user can refer to the output risk and countermeasures to address the risk of failure occurrence for the first tire.

In the above embodiment, the controller 23 predicted the risk of failure occurrence for the tire 13 based on the accumulated amount of the failure occurrence factors over the entire period from the time the tire 13 was mounted on the vehicle 10 to the present. However, the controller 23 may predict the risk of failure occurrence for the tire 13 based on the accumulated amount of the failure occurrence factors over a predetermined period. The predetermined period may be determined according to the type of failure occurrence factors and the like. The predetermined period may be, for example, three days, one week, or one month retroactively from the present. The risk prediction system 1 can evaluate the risk due to failure occurrence factors by setting these periods.

As described above, according to the risk prediction system 1 of the embodiment of the present disclosure, it is possible to improve the technology for predicting the risk of failure occurrence in tires. In particular, according to the risk prediction system 1, it is possible to predict the risk of failure occurrence for the first tire based on the history of measurement values of data items that quantitatively indicate the failure occurrence factors. This enables prediction of the risk corresponding to failures that occur due to the accumulation of failure occurrence factors and presentation to the user.

Further, the risk prediction system 1 of the embodiment of the present disclosure can predict the risk of failure occurrence based on the fatigue accumulation state of the tire 13 as the failure occurrence factor. For example, by including the internal temperature of the tire 13 as a data item, the risk prediction system 1 can predict the risk of failure occurrence for the tire 13 using the fatigue accumulation state due to thermal aging caused by the internal temperature of the tire 13 and the like as the failure occurrence factor. Further, for example, by including the acceleration of the vehicle 10 as a data item, the risk prediction system 1 can predict the risk of failure occurrence for the tire 13 using the fatigue accumulation state due to strain caused by the acceleration of the vehicle 10 and the like as the failure occurrence factor. The risk prediction system 1 can present the predicted risk to the user.

In addition, the risk prediction system 1 presents the risk to the user in stages by predicting the importance of the risk of failure occurrence for the tire 13 and the timing of failure occurrence, dividing the risk into two or more stages. This enables the user to grasp the risk situation and take necessary and sufficient countermeasures. Further, the risk prediction system 1 can present multiple countermeasures to the user in stages based on the predicted risk.

Furthermore, since the risk prediction system 1 acquires data of tires discarded in the past from users who require risk prediction, it is possible to perform analysis focused on the target tires for prediction.

In addition, since the risk prediction system 1 acquires the countermeasure policy data 22c and maintenance information 22d from the user, it is possible to present countermeasures corresponding to the user's countermeasure policy and maintenance timing and the like.

The embodiments of the present disclosure have been described above with reference to the drawings and examples, but it should be noted that various modifications or alterations can be easily made based on the present disclosure by those skilled in the art. Therefore, it should be noted that such modifications or alterations are included within the scope of the present disclosure. For example, the functions included in each component or each step can be rearranged as long as there is no logical inconsistency, and a plurality of components or steps can be combined into one or divided.

For example, the analysis unit 23a of the controller 23 in the information processing apparatus 20, which analyzes information on past discarded vehicles, and the past tire data 22a in the storage unit 22 may be disposed on hardware separate from the information processing apparatus 20. In this case, the threshold determined by the separate hardware is delivered to the information processing apparatus 20. Further, in the above embodiment, the display unit 34 of the terminal device 30 is used as the output interface, but the output interface may be a printer connected to the information processing apparatus 20. In this case, the risk of failure occurrence for the tire 13 output in list format by the printer, for example, may be delivered to the user. Furthermore, the information processing apparatus 20 and the terminal device 30 may be implemented on the same hardware.

Although the embodiments according to the present disclosure have been described mainly with reference to apparatuses, the embodiments according to the present disclosure can also be realized as methods including steps executed by each component of the apparatus. The embodiments according to the present disclosure can also be realized as methods executed by a processor included in the apparatus, as programs, or as storage media recording such programs. It should be understood that these are also included within the scope of the present disclosure.

### Contribution to the Sustainable Development Goals (SDGs) Led by the United Nations

The SDGs have been advocated for the realization of a sustainable society. One embodiment of the present disclosure is considered to be a technology that can contribute to, for example, “No. 12: Responsible Consumption and Production” and “No. 13: Climate Action.”

### REFERENCE SIGNS LIST

1 Risk prediction system
10 Vehicle
11 In-vehicle communication unit
12 In-vehicle sensor (measurement unit)
13 Tire (first tire)
14 Tire sensor (measurement unit)
20 Information processing apparatus (risk prediction apparatus)
21 Communication unit (acquisition interface)
22 Storage unit
22a Past tire data
22b In-use tire data
22c Countermeasure policy data
22d Maintenance information
23 Controller
23a Analysis unit
23b Risk prediction unit
30 Terminal device
31 Terminal communication unit
32 Terminal storage unit
33 Display unit (output interface)

1. A risk prediction system comprising:
a measurement unit configured to output measurement values of a data item that enables quantitative calculation of failure occurrence factors of each first tire mounted on a vehicle;
a controller configured to calculate an accumulated amount of the failure occurrence factors of each first tire based on a history of the measurement values of the data item, and predict a risk of failure occurrence for each first tire based on the accumulated amount; and
an output interface configured to output a risk of failure occurrence for each first tire based on the risk predicted by the controller.

2. The risk prediction system according to claim 1, wherein the data item includes one or a combination of two or more selected from environmental temperature, internal temperature of the first tire, internal air pressure of the first tire, loading weight of the vehicle, traveling speed of the vehicle, acceleration of the vehicle, and road gradient of a road traveled by the vehicle.

3. The risk prediction system according to claim 1, wherein the output interface displays, in stages, the risk of failure occurrence for each first tire based on the risk.

4. The risk prediction system according to claim 1, wherein the controller predicts the risk of failure occurrence for the first tire based on the accumulated amount of the failure occurrence factors over a predetermined period.

5. The risk prediction system according to claim 1, wherein the failure occurrence factors correspond to a fatigue accumulation state of the first tire.

6. The risk prediction system according to claim 5, wherein the fatigue accumulation state is a fatigue accumulation state due to thermal aging, and the data item includes an internal temperature of the first tire.

7. The risk prediction system according to claim 5, wherein the fatigue accumulation state is a fatigue accumulation state due to strain, and the data item includes acceleration of the vehicle.

8. The risk prediction system according to claim 1, further comprising an analysis unit configured to determine a threshold for the accumulated amount of the failure occurrence factors for predicting the risk, based on data of a plurality of discarded second tires, the data of each second tire including a cause of discarding the second tire and information on the history of the data item, wherein the cause of discarding the tire includes abnormality based failure and normal lifetime, and
the controller predicts the risk of failure occurrence for each tire using the threshold.

9. The risk prediction system according to claim 8, wherein the analysis unit includes two thresholds for the accumulated amount of the failure occurrence factors, and the two thresholds demarcate a range in which discarding occurs due to normal lifetime, a range in which discarding cannot be specifically identified as due to either normal lifetime or abnormality based failure, and a range in which discarding occurs due to abnormality based failure.

10. The risk prediction system according to claim 8, wherein the analysis unit acquires the data of the second tires including a plurality of data items and determines, from among the plurality of data items, the data item to be used for calculation of the failure occurrence factors based on types of the data items included in the plurality of data items and a required accuracy of the risk prediction.

11. The risk prediction system according to claim 8, wherein the data item is determined by a phenomenon of the abnormality based failure included in the data of the second tires.

12. The risk prediction system according to claim 8, wherein the controller predicts, based on the threshold, a timing at which failure occurs in each first tire by extrapolating the accumulated amount of the failure occurrence factors in a time series.

13. The risk prediction system according to claim 1, wherein the controller acquires maintenance information, including at least one of a maintenance frequency and a maintenance plan of the first tire, and determines a countermeasure for the risk based on the maintenance information and the accumulated amount of the failure occurrence factors of each first tire, and the output interface displays the determined countermeasure.

14. A risk prediction apparatus comprising:
an acquisition interface configured to acquire measurement values of a data item that enables quantitative calculation of failure occurrence factors of each first tire mounted on a vehicle;
a controller configured to calculate an accumulated amount of the failure occurrence factors of each first tire based on a history of the measurement values of the data item, and predict a risk of failure occurrence for each first tire based on the accumulated amount; and
an output interface configured to output a risk of failure occurrence for each first tire based on the risk predicted by the controller.

15. A risk prediction method to be executed by a computer, comprising:
acquiring measurement values of a data item that enables quantitative calculation of failure occurrence factors of each first tire mounted on a vehicle;
calculating an accumulated amount of the failure occurrence factors of each first tire based on a history of the measurement values of the data item;
predicting a risk of failure occurrence for each first tire based on the accumulated amount; and
outputting a risk of failure occurrence for each first tire based on the predicted risk.

16. The risk prediction system according to claim 2, wherein the output interface displays, in stages, the risk of failure occurrence for each first tire based on the risk.

17. The risk prediction system according to claim 2, wherein the controller predicts the risk of failure occurrence for the first tire based on the accumulated amount of the failure occurrence factors over a predetermined period.

18. The risk prediction system according to claim 2, wherein the failure occurrence factors correspond to a fatigue accumulation state of the first tire.

19. The risk prediction system according to claim 2, further comprising an analysis unit configured to determine a threshold for the accumulated amount of the failure occurrence factors for predicting the risk, based on data of a plurality of discarded second tires, the data of each second tire including a cause of discarding the second tire and information on the history of the data item, wherein the cause of discarding the tire includes abnormality based failure and normal lifetime, and
the controller predicts the risk of failure occurrence for each tire using the threshold.

20. The risk prediction system according to claim 2, wherein the controller acquires maintenance information, including at least one of a maintenance frequency and a maintenance plan of the first tire, and determines a countermeasure for the risk based on the maintenance information and the accumulated amount of the failure occurrence factors of each first tire, and the output interface displays the determined countermeasure.
